(19) United States
(12) Patent Application Publication
(10) Pub. No.: US 2010/0156267 A1
(43) Pub. Date: Jun. 24, 2010

(54) PLASMA DISPLAY PANEL

(75) Inventors: Tomonari MISAWA, Yokohama (JP); Yoshiho Seo, Yokohama (JP)

Correspondence Address: MILES & STOCKBRIDGE PC, 1751 PINNACLE DRIVE, SUITE 500, MCLEAN, VA, 22102-3833, US

(73) Assignee: HITACHI PLASMA DISPLAY LIMITED

(21) Appl. No.: 12/636,753

(22) Filed: Dec. 13, 2009

(30) Foreign Application Priority Data
Dec. 16, 2008 (JP) 2008-319385

(51) Int. Cl. H01J 17/49

(52) U.S. Cl. 313/487

(57) ABSTRACT

A plasma display panel has a first plate provided with a plurality of display electrodes extending in a first direction and a second plate in opposition to the first plate via a discharge space. The second plate is provided with a plurality of address electrodes extending in a second direction and a phosphor layer. The phosphor layer includes a magnesium oxide crystal and a plurality of kinds of phosphors, the phosphors being classified according to respective kinds. A surface of a particle of manganese-activated zinc silicate, which is one of the plurality of kinds of phosphors, is coated with a coating oxide which is at least one kind of element being oxidized. An electronegativity of the coating oxide is smaller than an average electronegativity of contained elements of zinc silicate excluding oxygen.

### CROSS REFERENCE TO THE RELATED APPLICATIONS

This application is based upon and claims the benefit of priority from Japanese Patent Application No. 2008-319385, filed on Dec. 16, 2008, the entire contents of which are incorporated herein by reference.

### BACKGROUND

1. Field

The present application relates to a plasma display panel.

2. Description of the Related Art

A plasma display panel (PDP) includes two glass plates (front glass plate and back glass plate) bonded to each other and displays an image by generating a discharge in a space (discharge space) formed between the glass plates. A cell corresponding to a pixel in the image is a self-luminescence type and applied with phosphors which emit visible lights of red, green and blue under ultraviolet rays emitted by the discharge.

In a general PDP, an X electrode and a Y electrode are arranged on the front glass plate and an address electrode is arranged on the back glass plate. On the address electrode, the above-described phosphors (phosphor layer) are provided with a dielectric layer interposed between the address electrode and the phosphors. The PDP having a three-electrode structure of this type displays an image by generating a sustain discharge between the X electrode and the Y electrode in a sustain period. A cell in which a sustain discharge is generated (cell to be lit) is selected by, for example, selectively generating an address discharge between the Y electrode and the address electrode in an address period. Before the address period, a reset period is provided to initialize all cells.

When the luminance of light generated by a discharge in the reset period (reset discharge) is high, the background luminance at the time of black display of the PDP becomes high and the contrast of the image (dark contrast) is reduced. In a general PDP, a reset discharge by a surface discharge between the X electrode and the Y electrode is performed. In recent years, a PDP has been proposed which prevents reduction of dark contrast by forming a phosphor layer including magnesium oxide (MgO) crystal that emits secondary electrons and by performing a reset discharge by an opposed discharge between the address electrode and the Y electrode in order to reduce the intensity of the opposed discharge using the address electrode arranged under the phosphor layer as a cathode (for example, refer to Japanese Unexamined Patent Application Publication No. 2008-66176).

### SUMMARY

Electrons emitted from the MgO crystal remain in the discharge space as priming electrons that serve as a discharge pilot light. Accordingly, when the electron emission performance of the MgO crystal is reduced, the number of the priming electrons remaining in the discharge space is reduced, and therefore, the opposed discharge using the address electrode arranged under the phosphor layer as the cathode becomes unstable. According to the research made attentively by the inventors of the present application, it has been made clear that when the phosphor emitting green visible light (green phosphor) is manganese-activated zinc silicate (Zn₂SiO₄:Mn), the electron emission performance of the MgO crystal included in the phosphor layer of the green phosphor is reduced due to long-time lighting, and the discharge using the address electrode arranged under the green phosphor layer as the cathode becomes unstable.

A proposition of the present embodiment is to provide a PDP that efficiently generates priming electrons when a discharge using the electrode on the phosphor side as a cathode is performed.

A plasma display panel has a first plate provided with a plurality of display electrodes extending in a first direction and a second plate in opposition to the first plate via a discharge space. For example, the second plate is provided with a plurality of address electrodes extending in a second direction which intersects the first direction, a barrier rib which partitions the discharge space, and a phosphor layer. For example, the phosphor layer includes a magnesium oxide crystal and a plurality of kinds of phosphors, the phosphors being classified according to respective kinds. Then, a surface of a particle of manganese-activated zinc silicate, which is one of the plurality of kinds of phosphors, is coated with a coating oxide which is at least one kind of element being oxidized. For example, an electronegativity of a contained element of the coating oxide excluding oxygen is smaller than an average electronegativity of contained elements of zinc silicate excluding oxygen when the contained element of the coating oxide other than oxygen is one kind of element. An average electronegativity of contained elements of the coating oxide excluding oxygen is smaller than the average electronegativity of contained elements of zinc silicate excluding oxygen when the contained elements of the coating oxide other than oxygen are a plurality of kinds of elements.

According to the present embodiment, it is possible to provide a PDP that efficiently generates priming electrons when a discharge using the electrode on the phosphor side as a cathode is performed.

### BRIEF DESCRIPTION OF THE DRAWINGS

FIG. 1 is a diagram showing essential parts of a PDP in an embodiment.

FIG. 2 is a diagram showing a section along a second direction of the PDP shown in FIG. 1.

FIG. 3 is a diagram showing a configuration example of a field to display an image of one screen.

FIG. 4 is a diagram showing an example of measurement waveforms to measure a discharge time lag.

FIG. 5 is a diagram showing a result of measurement of a discharge time lag in a plurality of samples.

FIG. 6 is a diagram showing an example of a relationship between the electronegativity of a coating oxide and the discharge time lag.

FIG. 7 is a diagram showing an example of a plasma display device configured using the PDP shown in FIG. 1.

### DETAILED DESCRIPTION OF THE EMBODIMENT

An embodiment of the present invention will be described below using the drawings.

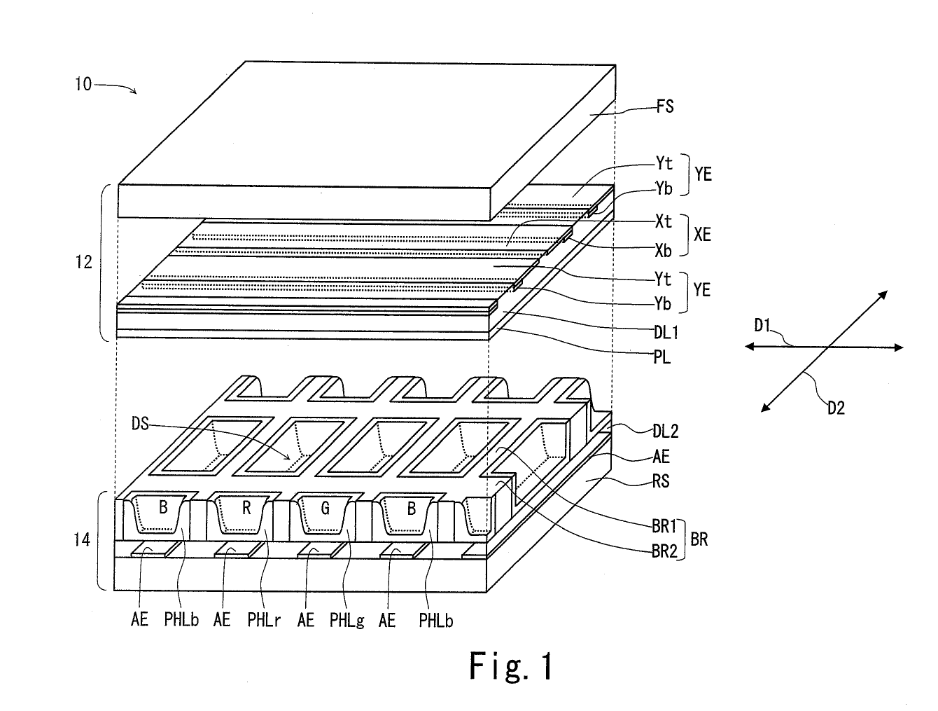

FIG. 1 shows essential parts of a plasma display panel (hereinafter, also referred to as a PDP) in an embodiment of the present invention. An arrow D1 in the figure indicates a first direction D1 and an arrow D2 indicates a second direction D2 perpendicular to the first direction D1 in a surface parallel with an image display surface. A PDP 10 includes a front plate part 12 (first plate) constituting the image display surface and a back plate part 14 (second plate) in opposition to the front plate part 12. Between the front plate part 12 and the back plate part 14 (in more detail, in a recess part of the back plate part), a discharge space DS is formed.

The front plate part 12 has a plurality of X electrodes XE (display electrodes, sustain electrodes) and Y electrodes YE (display electrodes, scan electrodes) which are provided extending in the first direction D1 on the surface of a glass base FS (the underside of the surface as shown in FIG. 1) in opposition to a glass base RS, and arranged with a distance apart from each others. The X electrode XE includes an X bus electrode Xb extending in the first direction D1 and an X transparent electrode Xt coupled to the X bus electrode Xb, and the Y electrode YE includes a Y bus electrode Yb extending in the first direction D1 and a Y transparent electrode Yt coupled to the Y bus electrode Yb. For example, between a pair of the X electrode XE and the Y electrode YE (more specifically, between the X transparent electrode Xt and the Y transparent electrode Yt), a discharge (sustain discharge) is generated repeatedly.

The X electrode XE and the Y electrode YE are covered with a dielectric layer DL1 and the surface of the dielectric layer DL1 is covered with a protective layer PL. The protective layer PL is formed by, for example, a magnesium oxide (MgO) film having high secondary electron emission characteristics by collision of positive ions in order to easily generate a discharge. For example, the electrons emitted from the protective layer PL, such as an MgO film, remain in the discharge space DS as priming electrons that serve as a discharge pilot light.

The back plate part 14 in opposition to the front plate part 12 via the discharge space DS has address electrodes AE formed in parallel with each others on the surface on the discharge space DS side of the glass base RS. The address electrodes AE are arranged extending in the direction perpendicular to the bus electrodes Xb, Yb (second direction D2). The address electrodes AE are covered with a dielectric layer DL2. In the dielectric layer DL2, a barrier rib BR to partition the discharge space DS is formed. For example, the barrier rib BR is formed into a lattice shape by a first barrier rib BR1 extending in the second direction D2 and a second barrier rib BR2 extending in the first direction D1. The barrier rib BR may not be provided with the second barrier rib BR2 but include only the first barrier rib BR1 extending in the second direction D2.

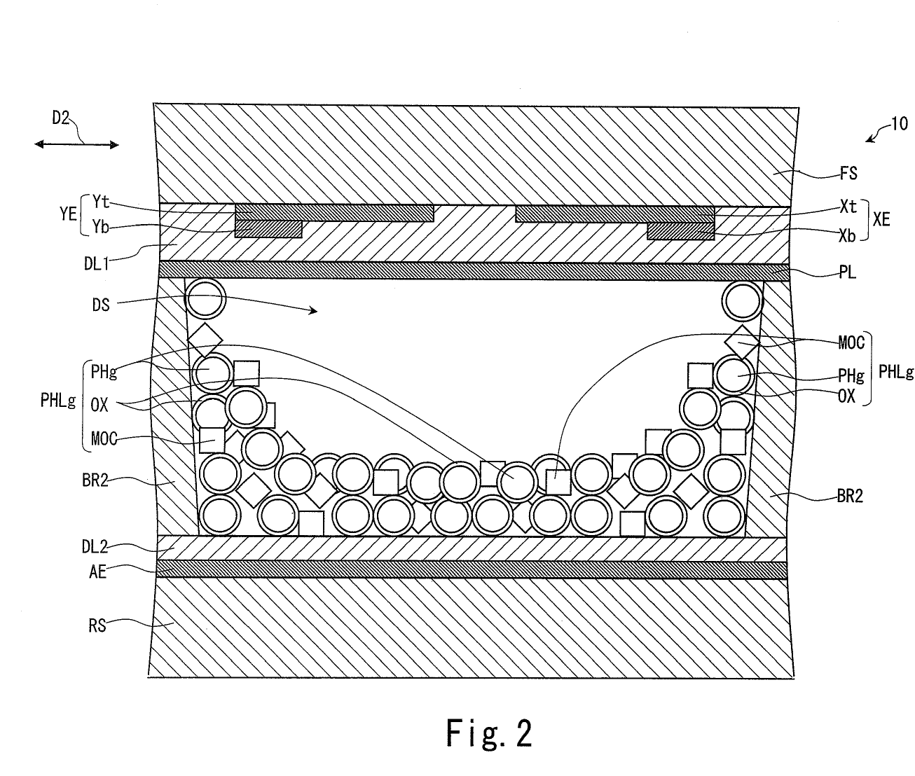

On the side surface of the barrier ribs BR1, BR2 and on the dielectric layer DL2 at a part surrounded by the barrier ribs BR1, BR2, phosphor layers PHLr, PHLg and PHLb that emit red (R), green (G) and blue (B) visible light, respectively, are provided. For example, the phosphor layer PHLg that emits green visible light has a phosphor (phosphor PHg in FIG. 2, to be described later) that emits green visible light when excited by ultraviolet rays, and MgO crystal (MgO crystal MOC in FIG. 2, to be described later) that emits electrons. Similarly, for example, the phosphor layer PHLr that emits red visible light has a phosphor (not shown schematically) that emits red visible light when excited by ultraviolet rays, and MgO crystal (not shown schematically) that emits electrons.

Further, for example, the phosphor layer PHLb that emits blue visible light has a phosphor (not shown schematically) that emits blue visible light when excited by ultraviolet rays, and MgO crystal (not shown schematically) that emits electrons. Hereinafter, when visible light is not distinguished by its colors, the phosphor layers PHLr, PHLg and PHLb are also referred to as a phosphor layer PHL. As described above, the phosphor layer PHL includes the MgO crystal and a plurality of kinds of phosphors, the phosphors being classified according to their kinds. Phosphors included in the phosphor layer PHL arranged on one address electrode AE are the same kind. That is, the phosphor layer PHL arranged on one and the same address electrode emits visible light of the same color.

Here, for example, the phosphor layer PHL is formed by printing a phosphor paste on the back plate part 14 using the screen printing method. For example, the phosphor paste is formed by blending phosphor, MgO crystal, and binder. Electrons emitted from the MgO crystal included in the phosphor layer PHL remain in the discharge space DS as priming electrons that serve as a discharge pilot light. Hereinafter, the electrons emitted from the protective layer PL, such as an MgO film, and the MgO crystal are also referred to as priming electrons.

One pixel of the PDP 10 includes three cells that emit red, green and blue light. Here, one cell (pixel of one color) is formed in a region surrounded by, for example, the barrier ribs BR1, BR2. In this manner, the PDP 10 is configured by arranging cells in a matrix and alternately arranging a plurality of kinds of cells that emit light of colors different from each others in order to display an image.

The PDP 10 is configured by bonding the front plate part 12 and the back plate part 14 together so that the protective layer PL and the barrier rib BR1 come into contact with each other and by filling the discharge space DS with a discharge gas, such as Ne and Xe.

FIG. 2 shows a section along the second direction D2 of the PDP 10 shown in FIG. 1. Here, FIG. 2 shows a section at a position where the phosphor layer PHLg is disposed. The meaning of the arrow D2 in the figure is the same as that in FIG. 1 described above. In the figure, in order to distinguish the MgO crystal MOC from the phosphor PHg, the MgO crystal MOC is represented by a rectangle and the phosphor PHg is represented by a circle (in more detail, an inner circle of the double circle).

As described above, the phosphor layer PHLg that emits green visible light has the phosphor PHg (hereinafter, also referred to as the green phosphor PHg) that emits green visible light when excited by ultraviolet rays, and the MgO crystal MOC that emits priming electrons. For example, the green phosphor PHg, which is one of the plurality of kinds of phosphor included in the phosphor layer PHL is manganese-activated zinc silicate (Zn₂SiO₄:Mn), and the surface of the particle (particle of manganese-activated zinc silicate) is coated with an oxide OX (hereinafter, also referred to as a coating oxide OX). For example, the coating oxide OX is one kind of element being oxidized (such as magnesium oxide, aluminum oxide (Al₂O₃), lanthanum oxide (La₂O₃)).

For example, the surface of the particle of the green phosphor PHg is coated with the coating oxide OX by immersing the particle of the green phosphor PHg (manganese-activated zinc silicate) in a solution that contains the contained elements (magnesium of magnesium oxide, aluminum of aluminum oxide, lanthanum of lanthanum oxide, etc.) of the coating oxide and baking it after sedimentation. Alternatively, the surface of the particle of the green phosphor PHg is coated with the coating oxide OX by blending the fine particle of the coating oxide OX and the particle of the green phosphor PHg (manganese-activated zinc silicate).

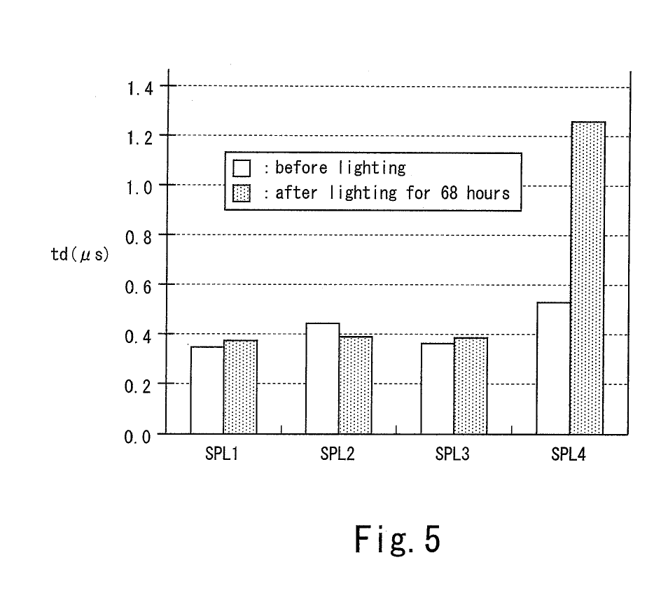

For example, in samples SPL1, SPL2 and SPL3 shown in FIG. 5, to be described later, the surface of the particle of the green phosphor PHg is coated with the coating oxide OX by blending the fine particle of the coating oxide OX and the particle of the green phosphor PHg (manganese-activated zinc silicate) in acetone and by drying them. Incidentally, for example, the phosphors that emit red and blue visible light are not subjected to the process to coat the surface of the particle with the coating oxide OX because it is not necessary to coat the surface of the particle with the coating oxide OX.

Further, for example, the MgO crystal MOC that emits priming electrons performs cathodoluminescence emission having its peak in a wavelength range of 200 to 300 nm.

Here, for example, the MgO crystal MOC may be formed so as to contain 50 ppm of fluorine. Here, “ppm” indicates the weight concentration.

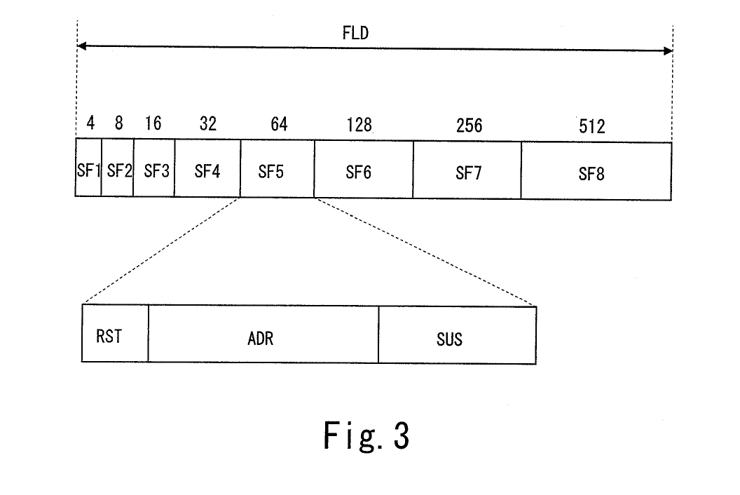

FIG. 3 shows a configuration example of a field FLD to display an image of one screen. The length of one field FLD is 1/60 sec (about 16.7 ms) and includes, for example, eight subfields SF (SF1 to SF8). In the example in the figure, each subfield SF has a reset period RST, an address period ADR, and a sustain period SUS.

The reset period RST is a period in which a reset discharge is generated in order to initialize all of the cells. For example, in the reset period RST, a voltage is applied between the address electrode AE and the Y electrode YE so that the address electrode AE comes to have a negative polarity with respect to the Y electrode YE. Consequently, a reset discharge by the opposed discharge between the address electrode AE and the Y electrode YE is generated. For example, by the reset discharge, the quantity of wall charges accumulated on each of the electrodes XE, YE and AE is adjusted and the firing voltages (voltage at which an address discharge starts to be generated in the address period ADR) of all of the cells are made to be the same. Here, the wall charge is, for example, a positive charge or a negative charge accumulated on the surface of the protective layer PL, such as MgO shown in FIG. 1.

The address period ADR is a period in which a cell to be lit in the sustain period SUS is selected. For example, a cell to be lit in the sustain period SUS is selected by selectively generating an address discharge between the Y electrode YE and the address electrode AE in the address period ADR.

The sustain period SUS is a period in which a sustain discharge is generated between the X electrode XE and the Y electrode YE of the cell selected in the address period ADR (the cell to be lit). For example, in the sustain period SUS, sustain pulses having polarities different from each other are applied repeatedly to the X electrode XE and the Y electrode YE. Consequently, a discharge (sustain discharge) of the cell selected in the address period ADR is generated repeatedly. In the sustain period SUS, in addition to the sustain discharge between the electrodes XE, YE, an opposed discharge using the address electrode AE as a cathode (discharge between the electrodes AE, YE and discharge between the electrodes AE, XE) is generated in a low ratio.

The length of the sustain period SUS differs for each subfield SF, depending on the number of times of discharge (luminance) of a cell. As a result, it becomes possible to display an image with multiple gradations by changing the combination of the subfields SF to be lit. In this example, the numbers of times of sustain discharge set in advance to the subfields SF1 to 8 are 4, 8, 16, 32, 64, 128, 256 and 512, respectively. For example, by one-time sustain discharge, a cell discharges twice.

It is only required for one field FLD to include a plurality of subfields SF and the filed FLD may include seven or less subfields SF or may include nine or more subfields SF. The number of times of sustain discharge in a subfield is not limited to an n-th power of 2 (n is an integer of 2 or greater). Further, it is not necessary to arrange the subfields SF1 to 8 in the field FLD in order. For example, the subfield SF8 may be disposed in the vicinity of the center of the field FLD.

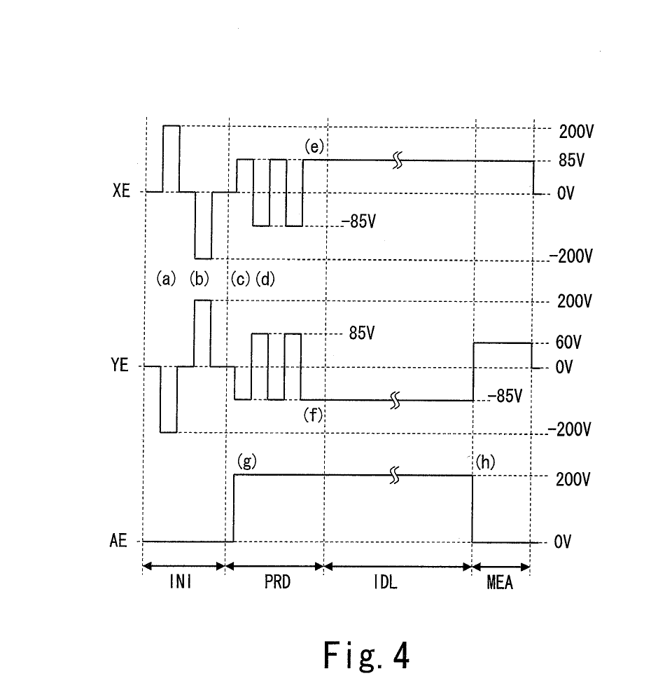

FIG. 4 shows an example of measurement waveforms for measuring a discharge time lag of the PDP 10 shown in FIG. 1. Further, FIG. 4 shows an example of a waveform of a voltage to be applied to each of the electrodes XE, YE and AE in order to measure a discharge time lag of a discharge using the address electrode AE, which is the electrode on the phosphor layer PHLg side shown in FIG. 2 described above, as a cathode. Here, a discharge time lag is, for example, a period of time from when a voltage of 60 V and a voltage of 0 V are applied to the Y electrode YE and the address electrode AE, respectively, to when a discharge is generated between the electrodes YE, AE in a measurement period MEA.

An initial period INI is a period in which a discharge is generated between the electrodes XE, YE and AE in order to initialize all of the cells. For example, in the initial period INI, positive and negative initial pulses (200 V, −200 V) are applied to the X electrode XE and the Y electrode YE, respectively (FIG. 4(a)). Then, the negative and positive initial pulses (−200 V, 200 V) are applied to the X electrode XE and the Y electrode YE, respectively (FIG. 4(b)). In the initial period INI, the address electrode AE is maintained at the middle voltage (0 V) of the positive and negative initial pulses.

A production period PRD is a period in which a priming electron is produced. For example, in the production period PRD, positive and negative production pulses (85 V, −85 V) are applied to the X electrode XE and the Y electrode YE repeatedly (FIGS. 4(c), 4(d)). Consequently, a discharge is generated between the electrodes XE, YE and a priming electron is produced. For example, by the collision of a positive ion with the protective layer PL, such as the MgO film shown in FIG. 1 described above, a priming electron is emitted from the protective layer PL, such as the MgO film.

Then, in a period of the production period PRD after the production pulse is applied a predetermined number of times (twice in the example in the figure), the X electrode XE is maintained at a high level voltage (85 V) of the positive production pulse (FIG. 4(e)) and the Y electrode YE is maintained at a low level voltage (−85 V) of the negative production pulse (FIG. 4(f)). Further, in the production period PRD, a bias voltage (200 V) is applied to the address electrode AE in synchronization with the first production pulse and then the address electrode AE is maintained at the bias voltage (200 V) (FIG. 4(g)). In the last period of the production period PRD, the quantity of wall charges to be accumulated on the electrodes XE, YE and AE is adjusted so that the voltage of the electrodes XE, YE and AE including the wall charges is the same.

In an idle period IDL, the last state of the production period PRD (state where 85 V, −85 V and 200 V are applied to the electrodes XE, YE and AE, respectively) is maintained to the measurement period MEA. For example, the length of the idle period IDL is 50 ms. Here, the number of priming electrons that have been generated is greatest immediately after the discharge (for example, immediately after the discharge generated in the production period PRD) and decreases gradually. Consequently, the number of priming electrons present in the discharge space DS decreases gradually in the idle period IDL.

The measurement period MEA is a period to measure a discharge time lag of a discharge using the address electrode AE, which is the electrode on the phosphor layer PHL side, as a cathode. Consequently, in the measurement period MEA, a voltage is applied between the Y electrode YE and the address electrode AE so that the address electrode AE has a negative polarity with respect to the Y electrode YE. For example, in the measurement period MEA, first, a first measurement voltage (60 V) and a second measurement voltage (0 V) are applied to the Y electrode YE and the address electrode AE, respectively (FIG. 4(h)).

That is, when the measurement period MEA starts, the voltage to be applied to the Y electrode YE changes from the voltage (−85 V) in the idle period IDL to the first measurement voltage (60 V) and the voltage to be applied to the address electrode AE changes from the voltage (200 V) in the idle period IDL to the second measurement voltage (0 V). Consequently, a discharge time lag is a period of time from the start of the measurement period MEA to the generation of a discharge between the electrodes YE, AE. In the measurement period MEA, the X electrode XE is maintained at the voltage (85 V) in the idle period IDL (last period of the production period PRD). As a result, a discharge is not generated between the electrodes XE, AE. In this manner, it is possible to measure a discharge time lag of a discharge using the address electrode AE, which is the electrode on the phosphor layer PHL side, as a cathode by applying the measurement waveforms shown in FIG. 4 to the electrodes XE, YE and AE.

FIG. 5 shows the result of measurement of a discharge time lag td in a plurality of samples. The discharge time lag td in each of the samples SPL1, SPL2, SPL3 and SPL4 in the figure shows a time when a cumulative discharge probability is 90% after measuring a period of time required for a discharge to start 1,000 times using the measurement waveform in FIG. 4 described above. Further, in the figure, “after lighting for 68 hours” (half-tone dot meshing) shows the discharge time lag td (in units of μs) after the PDP is lit for 68 hours (for example, after the PDP is kept in operation for 68 hours.), and “before lighting” in the figure shows the discharge time lag td (in unit of μs) before the PDP is lit for 68 hours. For example, the discharge time lag after the PDP is lit for 68 hours is a time when the cumulative discharge probability is 90% after measuring a period of time required for a discharge to start 1,000 times using the measurement waveforms in FIG. 4 after the PDP is lit for 68 hours.

The samples SPL1, SPL2 and SPL3 are those, in which the surface of the particle of the green phosphor PHg is coated with the coating oxide OX by blending the fine particle of the coating oxide OX and the particle of the green phosphor PHg (manganese-activated zinc silicate) in acetone and by drying them as explained in FIG. 2 described above. The coating oxides OX of the samples SPL1, SPL2 and SPL3 are magnesium oxide, aluminum oxide and lanthanum oxide, respectively. The sample SPL4 is the one for comparison, in which the surface of the particle of the green phosphor PHg is not coated with the coating oxide OX.

The MgO crystal included in the phosphor layer PHL is formed so as to contain 50 ppm of fluorine. Consequently, the phosphor paste used when forming the phosphor layer PHL is formed by blending the MgO crystal to which 50 ppm of fluorine is added, phosphor and binder. For example, in the samples SPL1, SPL2 and SPL3, the weight ratio between the green phosphor PHg coated with the coating oxide OX shown in FIG. 2 and the MgO crystal MOC to which 50 ppm of fluorine is added is 100:2.5. Further, for example, in the sample SPL4, the weight ratio between the green phosphor PHg not coated with the coating oxide OX and the MgO crystal MOC to which 50 ppm of fluorine is added is 100:2.5.

For the samples SPL1, SPL2 and SPL3 in which the surface of the particle of the green phosphor PHg is coated with the coating oxide OX, the discharge time lag td hardly changes before and after the PDP is lit for 68 hours but is stable near 0.4 μs. In contrast to this, for the sample SPL4 for comparison, in which the surface of the particle of the green phosphor PHg is not coated with the coating oxide OX, the discharge time lag td after the PDP is lit for 68 hours is about 1.25 μs, considerably deteriorated compared to the discharge time lag td (about 0.5 μs) before the PDP is lit for 68 hours.

Here, the discharge time lag varies depending on the quantity of priming electrons. As a result, it is possible to determine whether or not the priming electrons are generated efficiently by measuring the discharge time lag. That is, the result of measurement in FIG. 5 shows that priming electrons are generated efficiently in the samples SPL1, SPL2, SPL3, for example, after the PDP is lit for 68 hours and that in the sample SPL4, the priming electrons are not generated efficiently. Consequently, in the samples SPL1, SPL2 and SPL3, it is possible to generate the priming electrons efficiently even after the PDP is lit for 68 hours. In contrast to this, in the sample SPL4, it is not possible to generate the priming electrons efficiently after the PDP is lit for 68 hours.

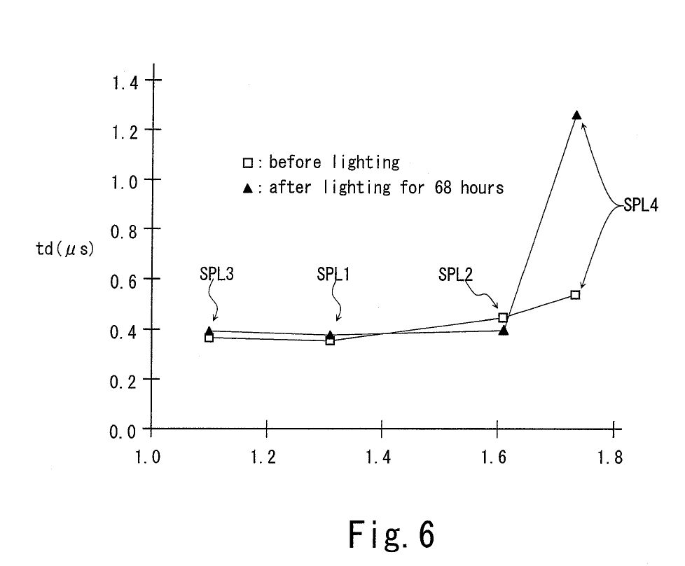

That is, it is possible to generate the priming electrons efficiently when performing a discharge using the address electrode AE (electrode on the phosphor layer PHL side) as a cathode by coating the surface of the particle (particle of manganese-activated zinc silicate) of the green phosphor PHg with the coating oxide OX. As will be explained in FIG. 6 to be described later, the electronegativity of a contained element of the coating oxide OX excluding oxygen is less than the average electronegativity of contained elements of zinc silicate excluding oxygen.

FIG. 6 shows an example of a relationship between the electronegativity of the coating oxide OX and the discharge time lag td. The meaning of “after lighting for 68 hours.” and “before lighting” is the same as that in FIG. 5 described above. That is, the black triangle in the figure shows the discharge time lag td (in units of μm) after the PDP is lit for 68 hours and the rectangle in the figure shows the discharge time lag td (in units of μs) before the PDP is lit for 68 hours. The discharge time lag td in each of the samples SPL1, SPL2, SPL3 and SPL4 in the figure shows a time when the cumulative discharge probability is 90% after measuring a period of time required for a discharge to start 1,000 times using the measurement waveforms in FIG. 4 described above.

Then, the horizontal axis in the figure represents the electronegativity of the coating oxide OX and the vertical axis represents the discharge time lag td (in units of μs). Here, the electronegativity of the coating oxide OX is an electronegativity of a contained element of the coating oxide OX excluding oxygen. The electronegativity of the coating oxide OX is the average electronegativity of contained elements of the coating oxide OX excluding oxygen when the contained elements of the coating oxide OX other than oxygen are a plurality of kinds of elements. The discharge time lag td in the sample SPL4 in the figure represents the discharge time lag td for the average electronegativity (1.73) of contained elements of zinc silicate (Zn₂SiO₄) excluding oxygen instead of the discharge time lag td for the electronegativity of the coating oxide OX.

For example, in the sample SPL1 (when the coating oxide OX is magnesium oxide), the electronegativity of the coating oxide OX is an electronegativity of 1.31 of magnesium because the contained element of the coating oxide OX excluding oxygen is only magnesium. Similarly, for example, in the sample SPL2 (when the coating oxide OX is aluminum oxide), the electronegativity of the coating oxide OX is an electronegativity of 1.61 of aluminum. For example, in the sample SPL3 (when the coating oxide OX is lanthanum oxide), the electronegativity of the coating oxide OX is an electronegativity of 1.1 of lanthanum.

In the sample SPL4 for comparison, in which the surface of the particle of the green phosphor PHg is not coated with the coating oxide OX, the average electronegativity of contained elements of zinc silicate (Zn₂SiO₄) excluding oxygen is calculated instead of the electronegativity of the coating oxide OX as described above. For example, the contained elements of zinc silicate excluding oxygen are two zinc (Zn) elements and one silicon (Si) element. Consequently, the average electronegativity of contained elements of zinc silicate excluding oxygen is calculated as 1.73 from the sum of two thirds of 1.65, the electronegativity of zinc, and one third of 1.90, the electronegativity of silicon (1.1+0.63=1.73).

As shown schematically, when the electronegativity of the coating oxide OX is 1.61 or less, the discharge time lag td hardly changes before and after the PDP is lit for 68 hours but is stable near 0.4 μs. Then, when the electronegativity is between 1.61 and 1.73, the discharge time lag td considerably changes before and after the PDP is lit for 68 hours. This suggests that there is a correlation between the deterioration of the MgO crystal MOC shown in FIG. 2 described above (for example, deterioration of priming electron emission performance) and the electronegativity of the coating oxide OX.

For example, FIG. 6 suggests that the discharge time lag td is 1.0 μs or less regardless of the lighting time when the surface of the particle of the green phosphor PHg (particle of manganese-activated zinc silicate) is coated with the oxide OX (coating oxide OX) of an element having an electronegativity of 1.67 ((1.61+1.73)/2) or less. That is, with a PDP having an electronegativity of 1.67 or less of the coating oxide OX, it is possible to generate the priming electrons efficiently when performing a discharge using the address electrode AE (electrode on the phosphor layer PHL side) as a cathode.

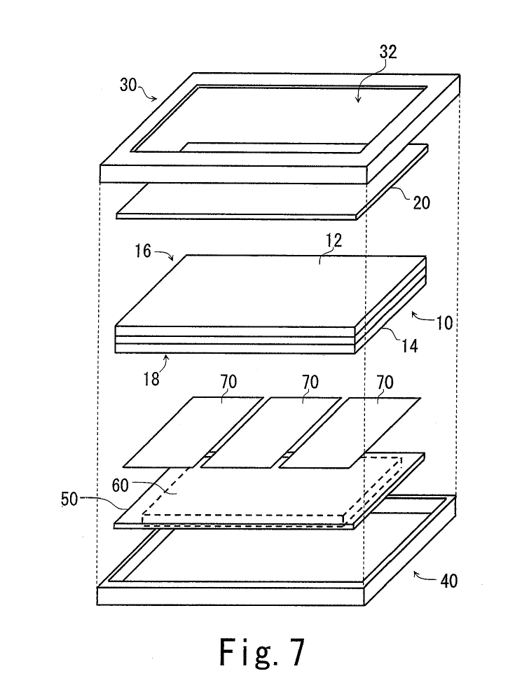

FIG. 7 shows an example of a plasma display device configured using the PDP 10 shown in FIG. 1. The plasma display device (hereinafter, also referred to as a PDP device) has the PDP 10 having the shape of a rectangular plate, an optical filter 20 provided on the side of an image display surface 16 of the PDP 10 (output side of light), a front case 30 disposed on the side of the image display surface 16 of the PDP 10, a rear case 40 and a base chassis 50 disposed on the side of a back 18 of the PDP 10, a circuit unit 60 attached to the side of the rear case 40 of the base chassis 50 for driving the PDP 10, and a double-faced adhesive sheet 70 for bonding the PDP 10 to the base chassis 50. The circuit unit 60 includes a plurality of parts, and therefore, it is depicted as a broken-lined box in the figure. The optical filter 20 is bonded to a protection glass (not shown schematically) to be attached to an opening part 32 of the front case 30. The optical filter 20 may have a function to shield electromagnetic waves. The optical filter 20 may be bonded directly to the side of the image display surface 16 of the PDP 10 instead of the protection glass.

As described above, in the present embodiment, the surface of the particle of the green phosphor PHg (particle of manganese-activated zinc silicate) is coated with the oxide (coating oxide OX) of an element having an electronegativity less than the average electronegativity of contained elements of zinc silicate excluding oxygen. Consequently, it is possible to reduce the discharge time lag td regardless of the lighting time of the PDP. In particular, when the coating oxide OX is one of magnesium oxide, aluminum oxide, and lanthanum oxide, it is possible to stabilize the discharge time lag td in a small value regardless of the lighting time of the PDP. That is, in the present embodiment, it is possible to provide a PDP capable of generating the priming electrons efficiently when performing a discharge that uses the address electrode AE, which is the electrode on the phosphor layer PHL side (phosphor side), as a cathode.

In the above-described embodiment, the example is described, in which one pixel includes three cells (red (R), green (G) and blue (B)). However, the present invention is not limited to the embodiment. For example, one pixel may include four or more cells. Alternatively, one pixel may include a cell that generates a green (G) color and a cell that generates a color other than red (R) and blue (B), or one pixel may include a cell that generates a color other than red (R), green (G) and blue (B).

In the above-mentioned embodiment, the example is described, in which the second direction D2 is orthogonal to the first direction D1. However, the present invention is not limited to the embodiment. For example, the second direction D2 may intersect the first direction D1 substantially perpendicular (for example, 90°±5°). In this case also, it is possible to obtain the same effect as that in the above-described embodiment.

In the above-described embodiment, the example is described, in which the coating oxide OX is formed by an oxide of one kind of element. However, the present invention is not limited to the embodiment. For example, the coating oxide OX may be a plurality of kinds of elements being oxidized. For example, it may be an oxide which is a plurality of kinds of elements including at least one of magnesium, aluminum and lanthanum being oxidized. That is, the coating oxide OX is at least one kind of element being oxidized. In this case, the average electronegativity of contained elements of the coating oxide OX excluding oxygen is calculated as the electronegativity of the coating oxide OX. Consequently, the average electronegativity of contained elements of the coating oxide OX excluding oxygen is less than the average electronegativity of contained elements of zinc silicate excluding oxygen. Alternatively, the average electronegativity of contained elements of the coating oxide OX excluding oxygen may be 1.67 or less. In this case also, it is possible to obtain the same effect as that in the above-described embodiment.

In the above-described embodiment, the example is described, in which the MgO crystal included in the phosphor layer PHL is formed so as to contain 50 ppm of fluorine. However, the present invention is not limited to the embodiment. For example, the MgO crystal contained in the phosphor layer PHL is only required to have the fluorine content of about 10,000 ppm or less and the fluorine content may be greater than 50 ppm or the fluorine content may be less than 50 ppm. That is, the MgO crystal included in the phosphor layer PHL may be formed so as to contain 1 to 10,000 ppm of fluorine or formed so as not to contain fluorine. In this case also, it is possible to obtain the same effect as that in the above-described embodiment.

The fluorine content (1 to 10,000 ppm) of the MgO crystal is calculated based on the experiment result of the PDP examined by the inventors of the present invention before the present invention has been made. For example, the PDP used in this experiment has the configuration of the sample SPL4 for comparison explained in FIG. 5 described above, from which the MgO crystal in the phosphor layer PHL is removed and to which a priming electron emission layer that covers the protective layer PL is added. For example, the priming electron emission layer is formed by MgO crystal to which fluorine is added. Then, the inventors of the present invention measured a plurality of samples having different fluorine contents from each other of the MgO crystal that forms the priming electron emission layer and examined a relationship between the fluorine content of the MgO crystal and the discharge time lag. In this configuration, a discharge is generated between the electrodes AE, YE using the electrode (Y electrode YE) on the side of the priming electron emission layer as a cathode and then the discharge time lag is measured. The length of the idle period (corresponding to the idle period IDL shown in FIG. 4 described above) when the discharge time lag is measured is 50 ms. An example of the experiment result of the PDP examined by the inventors of the present invention before the present invention has been made is shown below.

For example, when the fluorine content of MgO crystal of the PDP is 24 ppm, 48 ppm, 80 ppm, 160 ppm and 440 ppm, the discharge time lag is 0.431 μs, 0.484 μs, 0.485 μs, 0.474 μs and 0.622 μs, respectively. With the PDP in which the priming electron emission layer is formed by MgO crystal not including fluorine, the discharge time lag is 1.231 μs. As described above, when the fluorine content is in a range of 24 to 440 ppm, the change in the discharge time lag is small. Consequently, when the fluorine content is in a range of 1 to about 10,000 ppm, the change in the discharge time lag is small and it can be thought that the priming electrons are generated efficiently is suggested.

In the PDP shown in FIG. 1 described above, even when the MgO crystal included in the phosphor layer PHL is formed so as not to include fluorine, the surface of the particle of the green phosphor PHg (particle of manganese-activated zinc silicate) is coated with the coating oxide OX. As a result, in this case also, it is possible to prevent the discharge time lag td from deteriorating after the PDP is lit for a long time as shown in FIG. 5 and FIG. 6 described above. Consequently, in this case also, it is possible to provide a PDP capable of generating the priming electrons efficiently when performing a discharge using the electrode (address electrode AE) on the side of the phosphor layer PHL as a cathode.

In the above-described embodiment, the example is described, in which the MgO crystal MOC that performs cathodoluminescence emission having its peak in a wavelength range of 200 to 300 nm is included in the phosphor layer PHL. However, the present invention is not limited to the embodiment. For example, the MgO crystal MOC may have characteristics of performing cathodoluminescence emission having its peak in a wavelength range different from that of 200 to 300 nm. In this case also, it is possible to obtain the same effect as that in the above-described embodiment.

Although the present invention is described in detail as above, the above-described embodiment and its modified examples are only an example of the present invention and the present invention is not limited to those. It is obvious that the present invention can be modified within the scope not deviating from its gist.

The many features and advantages of the embodiment are apparent from the detailed specification and, thus, it is intended by the appended claims to cover all such features and advantages of the embodiment that fall within the true spirit and scope thereof. Further, since numerous modifications and changes will readily occur to those skilled in the art, it is not desired to limit the inventive embodiment to the exact construction and operation illustrated and described, and accordingly all suitable modifications and equivalents may be resorted to, falling within the scope thereof.

What is claimed is:

1. A plasma display panel, comprising:
a first plate provided with a plurality of display electrodes extending in a first direction;
a second plate in opposition to the first plate via a discharge space;
a plurality of address electrodes provided on the second plate and extending in a second direction which intersects the first direction;
a barrier rib provided on the second plate in order to partition the discharge space; and
a phosphor layer provided on the second plate and including a magnesium oxide crystal and a plurality of kinds of phosphors, the phosphors being classified according to respective kinds, wherein
a surface of a particle of manganese-activated zinc silicate, which is one of the plurality of kinds of phosphors, is coated with a coating oxide which is at least one kind of element being oxidized; and
an electronegativity of a contained element of the coating oxide excluding oxygen is smaller than an average electronegativity of contained elements of zinc silicate excluding oxygen when the contained element of the coating oxide other than oxygen is one kind of element, and an average electronegativity of contained elements of the coating oxide excluding oxygen is smaller than the average electronegativity of contained elements of zinc silicate excluding oxygen when the contained elements of the coating oxide other than oxygen are a plurality of kinds of elements.

2. The plasma display panel according to claim 1, wherein
the coating oxide comprises at least one kind of element having an electronegativity of 1.67 or less, in which an average electronegativity of contained elements of the coating oxide excluding oxygen is 1.67 or less when the contained elements of the coating oxide other than oxygen are a plurality of kinds of elements.

3. The plasma display panel according to claim 1, wherein
the magnesium oxide crystal has characteristics of performing cathodoluminescence emission having a peak in a wavelength range of 200 to 300 nm.

4. The plasma display panel according to claim 1, wherein
the magnesium oxide crystal contains 1 to 10,000 ppm of fluorine.

5. The plasma display panel according to claim 1, wherein
the coating oxide comprises at least one of magnesium, aluminum, and lanthanum.

6. The plasma display panel according to claim 5, wherein
the coating oxide is one of magnesium oxide, aluminum oxide, and lanthanum oxide.
